(19) United States
(12) Patent Application Publication
(10) Pub. No.: US 2010/0093332 A1
(43) Pub. Date: Apr. 15, 2010

(54) SYSTEM AND METHOD FOR CHANGING PROFILES OF A MOBILE PHONE

(75) Inventor: MING-CHU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/484,996

(22) Filed: Jun. 15, 2009

(30) Foreign Application Priority Data
Oct. 10, 2008 (CN) 200810304876.X

(51) Int. Cl. H04M 3/00; H04M 1/00

(52) U.S. Cl. 455/418; 455/550.1

(57) ABSTRACT

A profile changing system and method of a mobile phone set a task name and schedule time of a task, and predetermine a profile during the schedule time of the task in an electronic calendar of the mobile phone. The profile changing system and method further changes a default profile to the predetermined profile during the schedule time of the task, and restore the default profile when the task ends.

### BACKGROUND

1. Technical Field

Embodiments of the present disclosure are related to profiles management, and particularly to a system and method for changing profiles of a mobile phone.

2. Description of Related Art

Mobile phones are designed and built to be compact and lightweight. Since mobile phones are often used as personal organizers, they are typically installed with calendar programs. The calendar programs generally show arrangements of days, weeks, and months in a year. For practical purposes, some calendar programs also provide user activity information in a same view. The user activity information includes a date, start time, task name, and venue of each activity, for example.

Variations of such calendar programs have been proposed and commercialized for a variety of reasons. Most current calendar programs only provide user activity information for a selected day and an alarm according to a default ring setting before the time of the activity. However, the ring tone may all sound the same, which would disturb/confuse the user in some special circumstances. Thus, the user need to change the profiles manually when the user is in the special circumstances. For example, if the user is at a meeting and is inconvenient to answer an incoming call, then the user need to change the profile of the mobile phone to be “meeting” or “silence” to avoid the noise. Thus, it brings inconvenience to the user to change the profile of the mobile phone when the user is in the special circumstances.

What is needed, therefore, is an improved system and method for changing the profile of the mobile phone to overcome the above-stated problems and bring convenience to users of mobile phones.

### BRIEF DESCRIPTION OF THE DRAWINGS

FIG. 1 is a block diagram of one embodiment of a profiles changing system of a mobile phone.

FIG. 2 is a flowchart of one embodiment of a method for changing a profile of the mobile phone.

FIG. 3 is a schematic diagram of an interface of an electronic calendar of the mobile phone.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

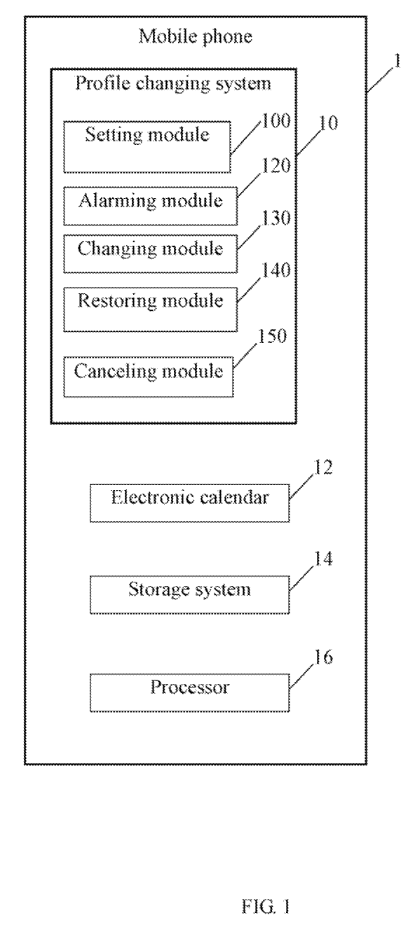

FIG. 1 is a block diagram of one embodiment of a system 10 for changing profiles of a mobile phone 1 (hereinafter referred to as “the profiles changing system 10”). In one embodiment, the mobile phone 1 includes an electronic calendar 12, a storage system 14 and a processor 16. The electronic calendar 12 provides a plurality of interfaces to set corresponding information of one or more tasks during various times and dates.

The storage system 14 stores one or more programs, such as computerized codes of the profiles changing system 10, programs of an operating system, and other applications of the mobile phone 1. Depending on the embodiment, the storage system 14 may include a memory of the mobile phone 1 or an external storage card, such as a memory stick, a subscriber identity module (SIM) card. The external storage card may be a smart media card (SMC), a secure digital card (SDC), a compact flash card (CFC), a multi media card (MMC), a memory stick (MS), an extreme digital card (XDC), and a trans flash card (TFC). The processor 16 executes programs of the profiles changing system 10 and the other applications, to provide functions of the mobile phone 1.

In one embodiment, the profiles changing system 10 may include a setting module 1000, an alarming module 120, a changing module 130, a restoring module 140, and a canceling module 150. The modules 100, 120, 130, 140, and 150 may be used to execute one or more operations on the mobile phone 1.

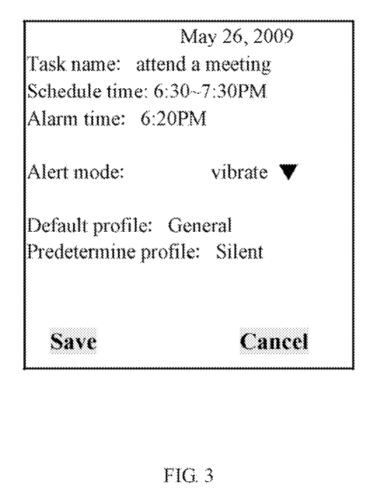

The setting module 100 sets one or more task names, a task schedule time, and a task alarm time in the electronic calendar 12. All the settings may be set through the interfaces provided by the electronic calendar 12. As shown in an interface of FIG. 3, the task names may define a task topic, for example, “attend a meeting” in FIG. 3. Each task schedule time may include a date, a start time, and an end time of the task. Further details will be provided below.

The setting module 100 further sets a default profile to each task in the electronic calendar 12, predetermines one or more alert modes, and profiles during the schedule time of the tasks. In one embodiment, the predetermined alert modes may be, but are not limited to, a ring setting, a vibration mode, or a mute setting of the mobile phone 1. Depending on the embodiment, the profiles includes general, silent/mute, meeting, outdoor, and some user-defined modes defined by the user of the mobile phone 1.

The alarming module 120 alarms the user of the mobile phone 1 according to the predetermined alert modes when task alarm time is reached.

The changing module 130 changes a default profile to a predetermined profile during the schedule time of a task. For example, in FIG. 3, the changing module 130 changes the default profile to the predetermined profile “silent” during the schedule time of “6:30-7:30 PM” on May 26, 2009.

The restoring module 14 restores the default profile when the task ends. It may be understood that restoring the default profile, in one embodiment, includes reverting back to the default profile upon ending the task.

The canceling module 150 cancels the task from the electronic calendar 12 after outputting the alert according to the predetermined alert mode, and/or cancels the task according to users' requirements before the schedule time of the task.

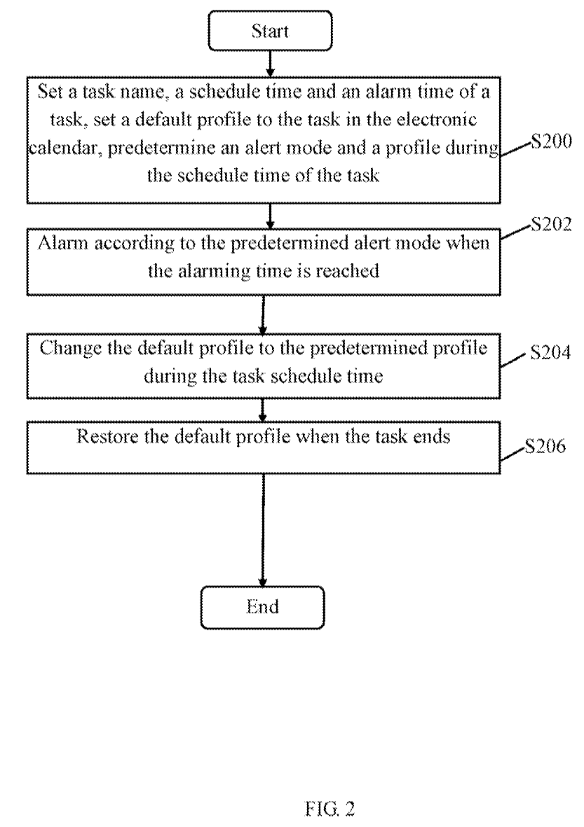

FIG. 2 is a flowchart of one embodiment of a method of changing a profile of the mobile phone 1. Depending on the embodiment, additional blocks may be added, others removed, and the ordering of the blocks may be changed.

In block S200, the setting module 100 of the mobile phone 1 sets a task name, schedule time, and task alarm time in an interface provided by the electronic calendar 12. The task names may define task topic, for example, “attend a meeting” in FIG. 3. Each task schedule time may include a date, a start time, and an end time of the task. The set date, is shown in an interface of FIG. 3, for example, “May 26, 2009”. Task alarm time is the time to ring so as to remind the user of the mobile phone 1 to pay attention to the task. For example, task alarm time is 6:20 PM. That is, the mobile phone 1 would ring at 6:20 PM to remind the user. Additionally, the setting module 100 sets a default profile to the task in the calendar and predetermines an alert mode and a profile during the schedule time of the task. In one embodiment, the predetermined alert mode may be, but is not limited to a ring setting, a vibration mode, or a mute setting of the mobile phone 1. Depending on the embodiment, the profiles includes general, silent, meeting, outdoor and some modes defined by the user of the mobile phone 1, for example.

In block S202, the alarming module 100 alarms according to the predetermined alert mode when task alarm time is reached. For example, task alarm time is 6:20 PM. That is, the mobile phone 1 would ring at 6:20 PM to remind the user.

In block S204, the changing module 130 changes the default profile to the predetermined profile during the schedule time of the task. For example, in FIG. 3, the changing module 130 changes the default profile to the predetermined profile “silent” during the schedule time of “6:30-7:30 PM” on May 26, 2009.

In block S206, The restoring module 14 restores the default profile when the task ends.

FIG. 3 is one embodiment of an interface of the electronic calendar 12. In the interface, the task name, schedule time, task alarm time, and predetermines the alert mode and the profile of task are set by using the setting module 100. After finishing all the settings, the user may click the button of “Save” or “Cancel” to save or cancel the task.

The above embodiments automatically changing profiles of the mobile phone 1 to bring convenience of the setting profiles when the user is under different circumstance.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method for changing a profile of a mobile phone comprising an electronic calendar, the method comprising:
setting a default profile of the mobile phone to a task in the electronic calendar;
setting a task name and a scheduled time of the task, and predetermining a profile for the mobile phone during the schedule time of the task in the electronic calendar;
changing the default profile to the predetermined profile during the scheduled time of the task; and
restoring the default profile when the task ends.

2. The method as claimed in claim 1, further comprising:
setting a task alarm time and predetermining an alert mode;
alarming a user of the mobile phone to remind the user of the task according to the predetermined alert mode at the task alarm time.

3. The method as claimed in claim 2, wherein the predetermined alert mode comprises a vibration mode, a ring setting, and a mute setting.

4. The method as claimed in claim 1, wherein the schedule time of the task comprises a date, a start time and an end time of the task.

5. A mobile phone comprising a profile changing system and an electronic calendar, the mobile phone further comprising:
a storage system;
at least one processor; and
one or more programs stored in the storage system and being executable by the at least one processor, the one or more programs comprising:
a setting module to set task names, schedule time of one or more tasks, default profiles to each task in the electronic calendar and predetermining profiles during the schedule time of the task in the electronic calendar;
a changing module to change the default profile to a predetermined profile during the schedule time of the task; and
a restoring module to restore the default profile when the task ends.

6. The mobile phone as claimed in claim 5, wherein the setting module is further configured to set a task alarm time and a predetermined alert mode.

7. The mobile phone as claimed in claim 6, further comprising an alarming module to alarm a user of the mobile phone of the task according to the predetermined alert mode at the task alarm time.

8. The mobile phone as claimed in claim 7, further comprising a canceling module to cancel the set task at the task alarm time.

9. The mobile phone as claimed in claim 7, wherein the predetermined alert mode comprises a vibration mode, a ring setting, and a mute setting.

10. The mobile phone as claimed in claim 5, wherein the schedule time of the task comprises a date, a start time and an end time of the task.

11. The mobile phone as claimed in claim 5, wherein the storage system is selected from the group consisting of a smart media card, a secure digital card, and a compact flash card.

12. A storage medium storing a set of instructions, the set of instructions capable of being executed by a processor to perform a profiles changing method of a mobile phone comprising an electronic calendar, the method comprising:
setting a default profile of the mobile phone to a task in the electronic calendar;
setting a task name and a scheduled time of the task, and predetermining a profile for the mobile phone during the schedule time of the task in the electronic calendar;
changing the default profile to the predetermined profile during the scheduled time of the task; and
restoring the default profile when the task ends.

13. The storage medium as claimed in claim 12, wherein the method further comprising:
setting a task alarm time and predetermined alert mode;
alarming a user of the mobile phone of the task according to the predetermined alert mode at the task alarm time.

14. The storage medium as claimed in claim 13, wherein the predetermined alert mode comprises a vibration mode, a ring setting, and a mute setting.

15. The storage medium as claimed in claim 12, wherein the schedule time comprises a date, a start time and an end time of the task.
